(19) United States
(12) Patent Application Publication
(10) Pub. No.: US 2002/0189396 A1
(43) Pub. Date: Dec. 19, 2002

(54) Magnetic protection of hydraulic seal

(75) Inventor: Michael Lynn Hinds, Thibodaux, LA (US)

Correspondence Address: Jimmie R. Oaks, Patent Department, DEERE & COMPANY, One John Deere Place, Moline, IL, 61265-8098, US

(73) Assignee: Deere & Company, a Delaware corporation

(21) Appl. No.: 09/881,115

(22) Filed: Jun. 14, 2001

(51) Int. Cl. F16H 57/04; F16H 57/02

(52) U.S. Cl. 74/606 R; 74/467

(57) ABSTRACT

A cane harvester base cutter assembly includes a gearbox provided with an upper horizontal section that joins a pair of transversely spaced cylindrical wells. Each well has a bottom wall in which an upper drive shaft section of a base cutter leg is mounted for rotation. Each shaft section is received in a collar which is press fit into a hole in the associated well bottom wall and a seal is mounted on the shaft for preventing leakage along the interface between the shaft section and the sleeve. Ferric contaminants are prevented from falling onto the seals by ring-shaped contaminant collectors, including magnets, that are respectively mounted for rotation with the shafts at locations directly above the seals.

### FIELD OF THE INVENTION

The present invention relates to devices for capturing contaminants located in lubricating fluids, and more specifically relates to magnetic devices for capturing ferric contaminants.

### BACKGROUND OF THE INVENTION

It is well known to provide magnetic plugs and the like in the bottoms of oil reservoirs for capturing ferric materials that find their way into the reservoir and gravitate to the bottom. One common application of such plugs is in the sump of a gearbox. This is fine for gearboxes that have their rotating elements extending through the sides or top of the box. In gearboxes with the rotating elements extending through the bottom of the box, the seal for preventing leakage along the rotating element is located at the lowest part of the box and there is no room for a conventional magnetic plug. If the box is provided with a magnetic plug, it is installed at a level above the seal and is not effective since it is exposed only to a small amount of the oil entering the seal area. Thus any ferric contaminants generated by; the gears and bearings accumulate at the lowest elevation and thus over time cause seal deterioration.

### SUMMARY OF THE INVENTION

According to the present invention, there is provided an improved arrangement for protecting seals, that are located in the bottoms of oil sumps, from ferric contaminants.

A broad object of the invention is to provide a magnetic device located for effectively removing ferric contaminants from oil so as to prevent damage to a seal located in the bottom of the reservoir containing the oil.

A more specific object of the invention is to provide, in the environment of a gearbox having a sealed drive shaft extending from its the bottom, a magnetic arrangement mounted above the seal so as to intercept ferric contaminants as they gravitate towards the seal.

Yet a more specific object of the invention is to provide a magnetic arrangement in the form of a ring carrying magnet segments and to mount the ring on the drive shaft above the seal.

These and other objects of the invention will become apparent from a reading of the ensuing description together with the appended drawings.

### BRIEF DESCRIPTION OF THE DRAWINGS

FIG. 1 is a front elevational view of a base cutter assembly with which the present inventions particularly adapted for use.

FIG. 2 is a top plan view of the base cutter assembly shown in FIG. 1.

FIG. 3 is a perspective exploded view of the base cutter assembly shown in FIG. 1.

FIG. 4 is an enlarged view of one of the magnet carrying rings with magnets attached.

### DESCRIPTION OF THE PREFERRED EMBODIMENT

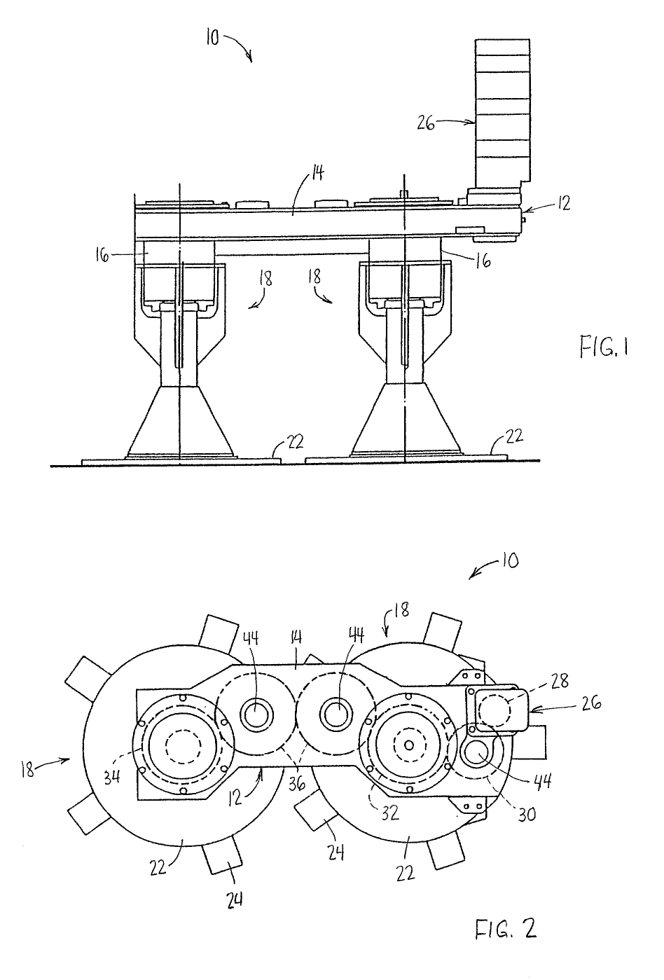

Referring now to FIGS. 1-3, there is shown a base cutter assembly 10 including a gearbox 12 having a shallow, horizontal upper section 14 extending between and joining a pair of transversely spaced, deep, cylindrical wells 16. Located beneath and in axial alignment with each cylindrical well 16 is an exposed portion of a base cutter leg assembly 18 including an upper shaft section 20 projecting axially upwardly through an opening provided in the bottom of the associated well 16. The bottom of each leg assembly 18 is defined by a circular blade mounting section 22 to which is mounted a plurality of cutting blades 24 (shown only in FIG. 2) spaced equally about the mounting section 22.

As can be seen in FIG. 2, the base cutter leg assemblies 18 are counter rotated by a drive train including a hydrostatic drive assembly 26 having a pinion gear 28 mounted on its output shaft and meshed with a first idler gear 30. The gear 30 is meshed with an input gear 32 of the left-hand base cutter assembly 18. Provided for transferring the rotation of the input gear 32 to an input gear 34 of the right-hand base cutter assembly 18 are identical, intermeshed second and third idler gears 36.

Thus it will be appreciated that clockwise rotation of the pinion gear 28 results in clockwise rotation of the left-hand base cutter input gear 32, and that this rotation of the gear 32 is transferred through the idler gears 36 to the right-hand base cutter input gear 34 to cause counter clockwise rotation of the right-hand base cutter assembly 18.

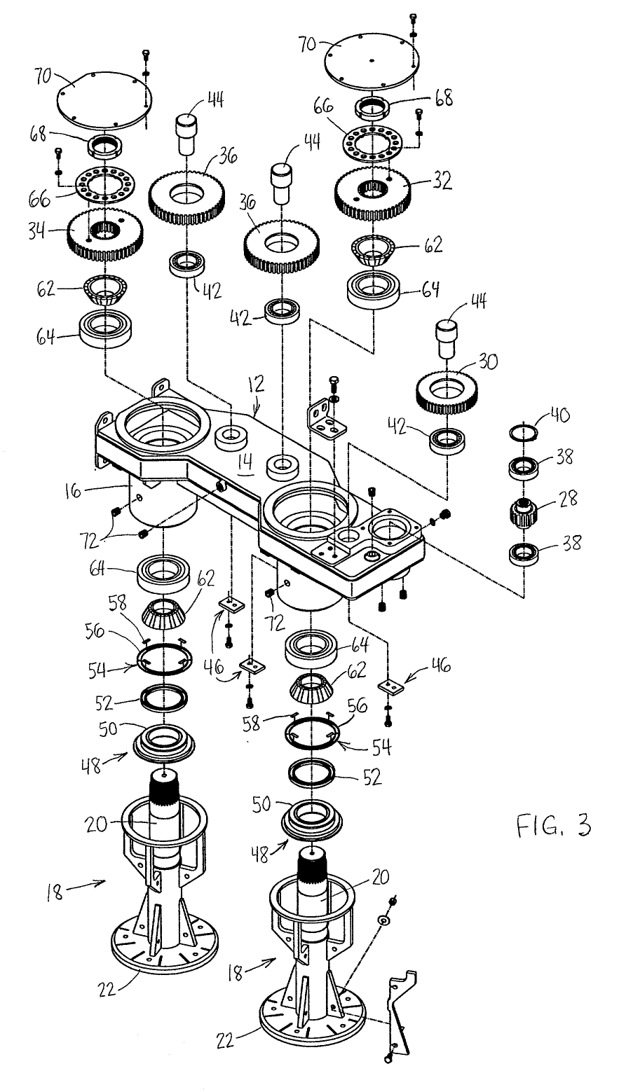

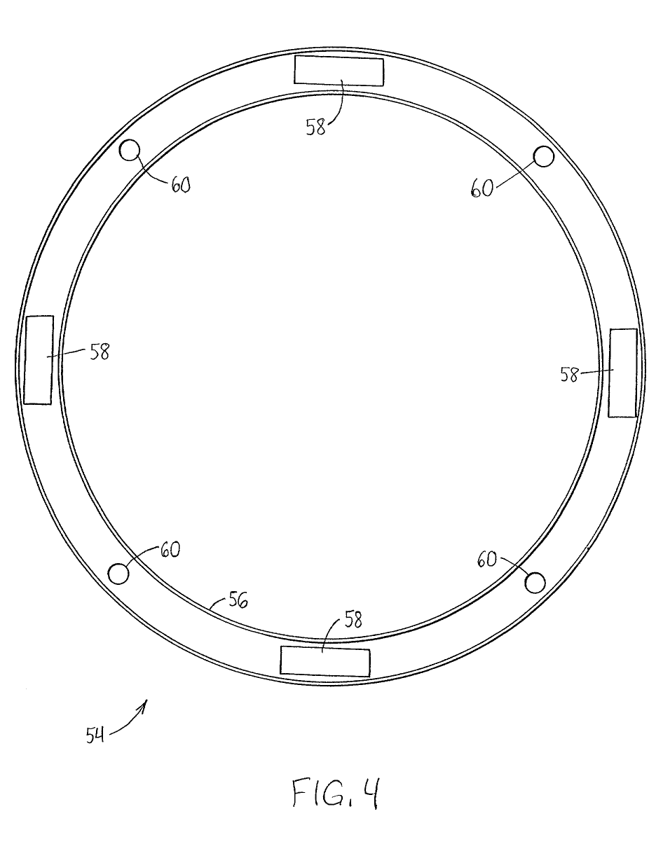

As can be seen in FIG. 3, the pinion gear 28 is mounted for rotation in the rear left-hand corner of the horizontal gearbox section 14 through the agency of upper and lower bearings 38 having inner races received on upper and lower stubs joined to the pinion gear 28 and having outer races pressed into cylindrical sections of the gearbox section 14. An internal snap ring 40 holds the assembled pinion gear 28 and bearings 38 in place. The first idler gear 30 is rotatably mounted in the gearbox section 14 by a bearing 42 pressed into the center of the gear 30 and having its inner race received on a lower reduced diameter section of an idler mounting pin 44 having its upper end pressed into a bore in the top of the gearbox section 14 and having its lower end held in place by a pin retainer assembly 46. The identical idler gears 36 are rotatably mounted in a fashion similar to the idler gear 30 by respective bearings 42, pins 44 and pin retainer assemblies 46.

Each of the base cutter assemblies 18 is rotatably mounted in the gearbox 12 in an identical fashion. Specifically, pressed into a cylindrical opening in the bottom of each of the cylindrical wells 16 is a sleeve 48 having a reduced diameter upper end section 50 located within the associated well. Received in each sleeve 48 is the upper shaft section 20 of an associated base cutter assembly 18 and received on the shaft section 20 in sealing relationship to the interface of the sleeve 48 and the shaft section 20 is a seal 52.

Forming the subject of the present invention is a ferric material contaminant collector 54 (see FIG. 4) including a metal magnet mounting ring 56 having an upwardly opening, U-shaped cross section defining a circular channel. The ring 56 is press fit onto the shaft section 20 for rotation with the shaft section at a location immediately above the seal 52. Located at equally spaced locations within the channel of the ring 56 are a plurality of permanent magnets 58 that are secured to the ring 56 by epoxy cement. Provided in the bottom of the channel between each adjacent pair of magnets 58 is a hole 60 which allows oil into the seal area for cooling. While four magnets 58 and holes 60 are illustrated, it is to be understood that more or fewer magnets and holes may be used to good advantage.

The remainder of the mounting for each of the base cutting assemblies 18 includes a lower tapered bearing cone 62 located on the shaft section 20 with its base adjacent the contaminant collector 52. A lower bearing cup 64 is received on the bearing cone 62. An identical bearing cup 64 is located on top of the lower bearing cup and receives an upper tapered bearing cone 62 oriented with its base up. The input gears 32 and 34 are respectively splined to the tops of the respective base cutter shaft sections 20, and each is followed by a flat retainer nut 66, a lock nut 68 and a circular cover plate 70.

Provided for removing ferric contaminants from the oil contained in the gearbox 12 are three magnetic plugs 72, located one each at elevated locations in the front of the cylindrical wall of each of the wells 16, and in a front central location of the horizontal gearbox section 14 between the wells 16.

The operation of the invention is thought to be clear from the foregoing description. Suffice it to say that during operation of the base cutter assembly 10, the rotating gears will wear resulting in ferric particles being deposited in the oil contained in the gearbox 12. Since these particles are heavier than the oil, the will gravitate to the bottom surfaces of the horizontal gearbox section 14 and the wells 16, with the particles or contaminants in the section 14 eventually finding their way to the wells 16 as the machine carrying the base cutter assemblies 16 moves over undulations in the terrain resulting in the gearbox 12 being tilted from side to side.

When the ferric particles enter the wells 16, they will settle down toward the contaminant collector 54 and become trapped by the magnets 58 which are rotating with the shaft section 20 so as to pass through the oil. Thus it will be appreciated that these contaminants are prevented from reaching and abrading the seals 52, which, as a result, will have a longer wear life. So that the cooling of the seals 52 by the oil is not impeded by the presence of the contaminant collector 54, the holes 60 allow the oil to move past the seals 52.

It will be appreciated that even though the gearbox 12 is provided with the magnetic plugs 72 for retaining ferric contaminants found in the oil, these plugs are not located low enough to be effective in removing a sufficient percentage of the contaminants so as to result in the life of the seals 52 being prolonged.

While the present invention has been described in conjunction with the gearbox of a base cutter assembly for a sugar cane harvester, it is to be understood that the invention would be applicable to any gearbox having a drive shaft extending through the bottom wall of a low portion of the gearbox.

Having described the preferred embodiment, it will become apparent that various modifications can be made without departing from the scope of the invention as defined in the accompanying claims.

1. In a gearbox containing gearing and having a low section having a bottom wall, a rotatable drive shaft extending through said bottom wall and a seal located for preventing oil from leaking along an interface including a surface section of the shaft where it enters the gearbox, the improvement comprising: a contaminant collector having magnetic characteristics being mounted in said gearbox in a location closely adjacent a top surface of said seal so as to intercept and collect ferric contaminants before they engage the seal.

2. The gearbox defined in claim 1 wherein said contaminant collector is mounted for rotation with said shaft.

3. The gearbox as defined in claim 2 wherein said contaminant collector includes a ring press fit onto said shaft.

4. The gearbox defined in claim 3 wherein said magnetic characteristic is achieved by there being at least one magnetic component fixed as an integral part to an upper surface of said ring.

5. The gearbox defined in claim 4 wherein said ring is shaped so as to define an upwardly opening, annular channel; and said at least one magnetic component being a magnet located in said channel.

6. The gearbox defined in claim 5 wherein said channel is provided with at least one hole permitting oil to pass to said seal for cooling it.

7. The gearbox defined in claim 3 wherein said ring is shaped so as to define and upwardly opening, annular channel; and said magnetic characteristic being due to a plurality of magnets fixed in said channel at spaced locations.

8. The gearbox defined in claim 7 wherein a hole is provided between adjacent pairs of said magnets so as to permit oil to pass to said seal for cooling it.

9. In a sugar cane base cutter assembly including a gearbox provided with an upper, horizontal section extending between and joining a pair of depending wells, each well having a bottom wall, an upper drive shaft section of a base cutter leg being rotatably mounted in each bottom wall, and a seal being located on each shaft section at an associated bottom wall for preventing leakage of oil from said gearbox along the shaft section, the improvement comprising: a contaminant collector having a magnetic characteristic being mounted above and closely adjacent each seal so as to intercept ferric contaminants settling towards the associated seal.

10. The base cutter assembly defined in claim 9 wherein each of said contaminant collectors is mounted for rotation with an associated one of the shaft sections.

11. The base cutter assembly defined in claim 10 wherein said contaminant collectors each include a ring press fit onto said associated one of the shaft sections.

12. The base cutter assembly defined in claim 11 wherein said magnetic characteristic of each contaminant collector is achieved by at least one magnet being fixed to each ring.

13. The base cutter assembly defined in claim 11 wherein each ring is formed so as to define an upwardly opening, annular channel; and said at least one magnet being located in said channel.

14. The base cutter assembly defined in claim 13 wherein at least one hole is provided in each ring to permit passage of oil from said channel to the associated seal to cool the seal.

15. The base cutter assembly defined in claim 11 wherein each ring is formed so as to define and upwardly opening, annular channel; and said magnetic characteristic of each contaminant collector being achieved by a plurality of magnets being fixed to the associated ring in spaced relationship to each other in said channel.

16. The base cutter assembly defined in claim 15 wherein a hole is provided in each of said rings between adjacent pairs of said plurality of magnets so as to permit oil to pass for cooling the seal.
